(19) United States
(12) Patent Application Publication
(10) Pub. No.: US 2026/0329514 A1
(43) Pub. Date: Oct. 22, 2026

(54) SCREEN PROJECTION FRAME RATE ACQUISITION METHOD, APPARATUS, COMPUTER DEVICE, AND STORAGE MEDIUM

(71) Applicant: SHENZHEN TCL NEW TECHNOLOGY CO., LTD., Shenzhen, Guangdong (CN)

(72) Inventor: Bobo QUAN, Shenzhen, Guangdong (CN)

(73) Assignee: SHENZHEN TCL NEW TECHNOLOGY CO., LTD., Shenzhen, Guangdong (CN)

(21) Appl. No.: 19/105,771

(22) PCT Filed: Feb. 1, 2024
(86) PCT No.: PCT/CN2024/075358

§ 371 Date: Feb. 21, 2025

(30) Foreign Application Priority Data
Feb. 13, 2023 (CN) 202310139841.X

(51) Int. Cl. G06F 3/14

(52) U.S. Cl. CPC G06F 3/1454

(57) ABSTRACT

A screen projection frame rate acquisition method, an apparatus, a computer device, and a storage medium are provided. The method includes: collecting an image frame sequence; acquiring a brightness difference sequence of the image frame sequence; determining a picture state type of the image frame sequence and a corresponding screen projection frame rate based on the brightness difference sequence; and sending image frames in the image frame sequence to a second terminal at the screen projection frame rate.

This application claims priority to Chinese Patent Applications No. 202310139841.X, filed on Feb. 13, 2023 and entitled “METHOD AND APPARATUS FOR ACQUIRING SCREEN-MIRRORING FRAME RATE, AND COMPUTER DEVICE AND STORAGE MEDIUM”. The entire disclosures of the above application are incorporated herein by reference.

### TECHNICAL FIELD

The present application relates to the field of terminal screen projection technologies, and in particular to a screen projection frame rate acquisition method, an apparatus, a computer device, and a storage medium.

### BACKGROUND TECHNOLOGY

With the development of science and technology, terminal devices are becoming more and more diversified, and screen projection technology has also been widely used. Screen projection refers to sending a content of one terminal to another terminal for display. For example, a picture content displayed on a mobile phone screen is projected onto a TV for display. During a screen projection process, a sending device will continuously sample image data of a screen picture at a certain frame rate, and send the collected image data to a receiving device. However, when a screen of the sending device is a static picture or a slowly changing picture, the image data obtained by sampling the screen picture is often unchanged. Continuously sending the same image data to the receiving device often causes a waste of power consumption of the terminal device.

### Technical Problem

During a screen projection process, a sending device will continuously sample a screen picture at a certain frame rate and send collected image data to a receiving device. Continuously sending the same image data to the receiving device often causes a waste of power consumption of a terminal device.

### SUMMARY OF INVENTION

Based on this, it is necessary to provide a screen projection frame rate acquisition method, an apparatus, a computer device, and a storage medium to address the above technical problems, so as to reduce the power consumption of the device during the screen projection process.

In a first aspect, the present application provides a screen projection frame rate acquisition method, applied to a first terminal, and the method includes: collecting an image frame sequence to be projected; acquiring brightness difference information between every two adjacent image frames in the image frame sequence to obtain a brightness difference sequence of the image frame sequence; determining a picture state type of the image frame sequence and a screen projection frame rate corresponding to the picture state type based on the brightness difference sequence; sending image frames in the image frame sequence to a second terminal at the screen projection frame rate.

In some embodiments of the present application, the acquiring the brightness difference information between every two adjacent image frames in the image frame sequence includes: acquiring first brightness information based on pixel information of a preset area in a first image frame; acquiring second brightness information based on pixel information of a preset area in a second image frame; where the first image frame and the second image frame are two adjacent image frames in the image frame sequence; calculating a difference value between the first brightness information and the second brightness information to obtain the brightness difference information between the first image frame and the second image frame.

In some embodiments of the present application, the preset area includes a first area with a first reference line as a center line and a second area with a second reference line as a center line; where the first reference line and the second reference line are reference lines with different directions.

In some embodiments of the present application, the preset area includes a first rectangular area with a first reference line as a center line and a second rectangular area with a second reference line as a center line; where the first reference line is parallel to a horizontal axis of an image frame, and the second reference line is parallel to a vertical axis of the image frame.

In some embodiments of the present application, before acquiring the brightness difference information between every two adjacent image frames in the image frame sequence, the method further includes: determining the first reference line and the second reference line based on a center point of the image frame in the image frame sequence; determining the preset area in the first image frame and the preset area in the second image frame based on the first reference line and the second reference line.

In some embodiments of the present application, before acquiring the brightness difference information between every two adjacent image frames in the image frame sequence, the method further includes: acquiring a differential pixel point between the first image frame and the second image frame; determining the first reference line and the second reference line in the second image frame and the first image frame based on the differential pixel point; acquiring the preset area in the first image frame and the preset area in the second image frame based on the first reference line and the second reference line.

In some embodiments of the present application, the picture state type includes a dynamic picture type and a static picture type; the determining the picture state type of the image frame sequence and the screen projection frame rate corresponding to the picture state type based on the brightness difference sequence includes: if a continuous preset number of brightness difference information in the brightness difference sequence are all greater than a first brightness threshold, determining that the image frame sequence is the dynamic picture type, and determining that the screen projection frame rate is a first frame rate; if the continuous preset number of brightness difference information in the brightness difference sequence are all less than or equal to the first brightness threshold, determining that the image frame sequence is the static picture type, and determining that the screen projection frame rate is a second frame rate; the first frame rate is greater than the second frame rate.

In some embodiments of the present application, before acquiring the brightness difference information between every two adjacent image frames in the image frame sequence to obtain the brightness difference sequence of the image frame sequence, the method further includes: acquiring a transmission bandwidth between the second terminal; correspondingly, the acquiring the brightness difference information between every two adjacent image frames in the image frame sequence to obtain the brightness difference sequence of the image frame sequence includes: if the transmission bandwidth is greater than a preset bandwidth threshold, acquiring the brightness difference information between every two adjacent image frames in the image frame sequence to obtain the brightness difference sequence of the image frame sequence.

In some embodiments of the present application, after acquiring the transmission bandwidth between the second terminal, if the transmission bandwidth information is less than or equal to the preset bandwidth threshold, the image frames in the image frame sequence are sent to the second terminal at a fixed frame rate.

In some embodiments of the present application, the sending the image frames in the image frame sequence to the second terminal at the screen projection frame rate includes: determining a screen projection interval time based on the screen projection frame rate; acquiring a latest collected target image frame in the image frame sequence and an actual interval time between the target image frame and a previously sent image frame; if the actual interval time is less than the screen projection interval time, discarding the target image frame; if the actual interval time is greater than or equal to the screen projection interval time, sending the target image frame to the second terminal.

In some embodiments of the present application, after determining the screen projection frame rate corresponding to the picture state type, the method further includes: sending the screen projection frame rate to the second terminal so that the second terminal displays a received image frame according to the screen projection frame rate.

In a second aspect, the present application provides a screen projection frame rate acquisition apparatus, the apparatus includes: an image collection module configured to collect an image frame sequence to be projected; a brightness difference acquisition module configured to acquire brightness difference information between every two adjacent image frames in the image frame sequence to obtain a brightness difference sequence of the image frame sequence; a frame rate determination module configured to determine a picture state type of the image frame sequence and a screen projection frame rate corresponding to the picture state type based on the brightness difference sequence; a screen projection module configured to send image frames in the image frame sequence to a second terminal at the screen projection frame rate.

In a third aspect, the present application further provides a computer device, the computer device includes: one or more processors; a memory; and one or more applications, where the one or more applications are stored in the memory and configured to be executed by the processor to implement the above-mentioned screen projection frame rate acquisition method.

In a fourth aspect, the present application further provides a computer-readable storage medium having a computer program stored thereon, the computer program is loaded by a processor to execute steps in the screen projection frame rate acquisition method.

### Beneficial Effects

In the above-mentioned screen projection frame rate acquisition method, apparatus, computer device, and storage medium, the image frame sequence to be projected is collected; the brightness difference information between every two adjacent image frames in the image frame sequence is acquired to obtain the brightness difference sequence of the image frame sequence; the picture state type of the image frame sequence and the screen projection frame rate corresponding to the picture state type are determined based on the brightness difference sequence; and the image frames in the image frame sequence are sent to the second terminal at the screen projection frame rate. The brightness difference information of the image frame sequence corresponding to the screen picture in the first terminal is used to detect the picture state type of the screen picture, and then the screen projection frame rate is dynamically adjusted based on the picture state type, thereby reducing terminal power consumption while ensuring smoothness of pictures during a projection process.

### BRIEF DESCRIPTION OF THE DRAWINGS

In order to more clearly illustrate technical solutions in embodiments of the present application, accompanying drawings required for use in a description of the embodiments are briefly introduced below. Apparently, the accompanying drawings described below are only some embodiments of the present application. For those skilled in the art, other drawings can be obtained based on these drawings without creative efforts.

FIG. 1 is a schematic diagram of a scene of a screen projection frame rate acquisition method in an embodiment of the present application.

FIG. 2 is a schematic diagram of a flowchart of a screen projection frame rate acquisition method in an embodiment of the present application.

FIG. 3 is a schematic diagram of a flowchart of a brightness difference information acquisition step between image frames in an embodiment of the present application.

FIG. 4A is a schematic diagram of a preset area in an image frame in an embodiment of the present application.

FIG. 4B is a schematic diagram of a preset area in another image frame in an embodiment of the present application.

FIG. 5A is a schematic diagram of a preset area in another image frame in an embodiment of the present application.

FIG. 5B is a schematic diagram of a preset area in another image frame in an embodiment of the present application.

FIG. 6 is a schematic diagram of a flowchart of another screen projection frame rate acquisition method in an embodiment of the present application.

FIG. 7 is a schematic diagram of a flowchart of another screen projection frame rate acquisition method in an embodiment of the present application.

FIG. 8 is a schematic diagram of a structure of a screen projection frame rate acquisition apparatus in an embodiment of the present application.

FIG. 9 is a schematic diagram of a structure of a computer device in an embodiment of the present application.

### DETAILED DESCRIPTION OF THE EMBODIMENTS

The technical solutions in the embodiments of the present application will be described clearly and completely below in conjunction with the accompanying drawings in the embodiments of the present application. Apparently, the described embodiments are only part of the embodiments of the present application, not all of them. Based on the embodiments in the present application, all other embodiments obtained by those skilled in the art without creative efforts are within the scope of protection of the present application.

In the description of the present application, terms “first” and “second” are used for descriptive purposes only and should not be understood as indicating or implying relative importance or implicitly indicating the number of technical features indicated. Therefore, features defined as “first” and “second” may explicitly or implicitly include one or more of the features. In the description of the present application, “plurality” means two or more, unless otherwise clearly and specifically defined.

In the description of the present application, a word “for example” is used to mean “used as an example, illustration, or explanation.” Any embodiment described in the present application as “for example” is not necessarily to be construed as being preferred or advantageous over other embodiments. The following description is given to enable any technician in the field to implement and use the present invention. In the following description, details are listed for the purpose of explanation. It should be understood that a person of ordinary skill in the art can recognize that the present invention can be implemented without using these specific details. In other instances, well-known structures and processes are not elaborated in detail to avoid obscuring the description of the present invention with unnecessary details. Therefore, the present invention is not intended to be limited to the embodiments shown, but is consistent with the widest scope consistent with the principles and features disclosed in the present application.

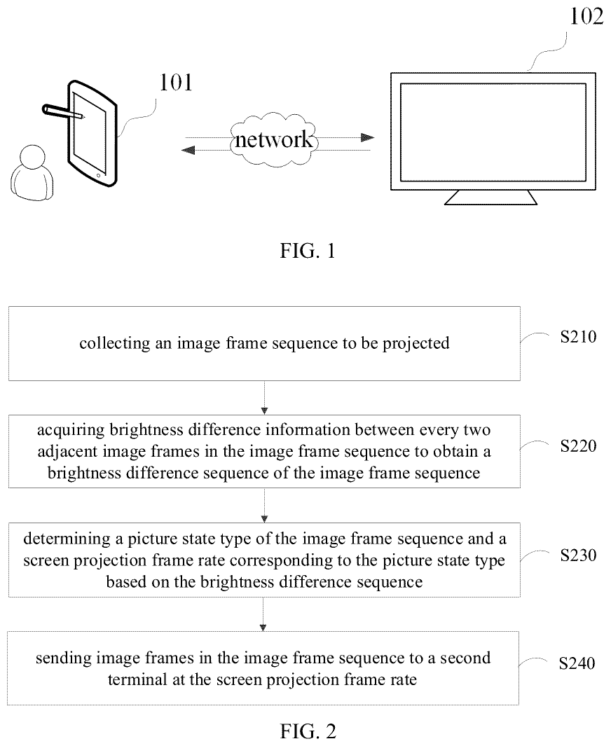

A screen projection frame rate acquisition method provided by an embodiment of the present application can be applied to a screen projection frame rate acquisition system shown in FIG. 1. The screen projection frame rate acquisition system includes a first terminal 101 and a second terminal 102. The first terminal 101 and the second terminal 102 can be cellular or other communication devices with a display, and can specifically be a desktop terminal or a mobile terminal, such as a mobile phone, a tablet computer, a laptop computer, a television, etc. Specifically, the first terminal 101 collects an image frame sequence to be projected; acquires brightness difference information between every two adjacent image frames in the image frame sequence to obtain a brightness difference sequence of the image frame sequence; determines a picture state type of the image frame sequence and a screen projection frame rate corresponding to the picture state type based on the brightness difference sequence; and sends image frames in the image frame sequence to the second terminal 102 at the screen projection frame rate.

Those skilled in the art will appreciate that an application environment shown in FIG. 1 is merely an application scenario of the present application solution and does not constitute a limitation on the application scenario of the present application solution. Other application environments may also include more or fewer computer devices than those shown in FIG. 1. For example, FIG. 1 only shows one second terminal 102. It is understandable that in the screen projection frame rate acquisition system, the first terminal 101 may also project the screen to one or more other terminals, which is not specifically limited here. In addition, as shown in FIG. 1, the screen projection frame rate acquisition system may also include a memory for storing data, such as storing specific values of the screen projection frame rate, image frames to be projected, and the like.

It should also be noted that the scene diagram of the screen projection frame rate acquisition system shown in FIG. 1 is only an example. The screen projection frame rate acquisition system and the scene described in the embodiments of the present invention are intended to more clearly illustrate the technical solutions of the embodiments of the present invention, and do not constitute a limitation on the technical solutions provided by the embodiments of the present invention. It is known to those skilled in the art that with the evolution of the screen projection frame rate acquisition system and the emergence of new business scenarios, the technical solutions provided by the embodiments of the present invention are also applicable to similar technical problems.

Referring to FIG. 2, an embodiment of the present application provides a screen projection frame rate acquisition method, which is mainly illustrated by applying the method to the first terminal 101 in FIG. 1. The method includes steps S210 to S240, which are specifically as follows:

Step S210, collecting an image frame sequence to be projected.

The image frame sequence includes multiple image frames; specifically, the first terminal can sample a content displayed on a display screen to obtain the image frame sequence.

Step S220, acquiring brightness difference information between every two adjacent image frames in the image frame sequence to obtain a brightness difference sequence of the image frame sequence.

The brightness difference information may refer to brightness difference values between different image frames. It is understandable that a human eye is more sensitive to the brightness in the image frame. By acquiring the brightness difference information between image frames for subsequent determination of a picture state type, an accuracy of the picture state type can be improved. Specifically, the brightness difference information between two adjacent image frames can be calculated based on pixel information of the two adjacent image frames. For example, YUV color space data or RGB color space data of pixel points in the image frame can be converted into brightness information of the image frame, and then the brightness difference information between the two adjacent image frames can be calculated based on the brightness information of the two adjacent image frames. For another example, a Y component value in the YUV color space data corresponding to the pixel point can be directly determined as the brightness information of the image frame, and then the brightness difference information between the two adjacent image frames can be calculated based on the brightness information of the two adjacent image frames.

Furthermore, the brightness difference information between two adjacent image frames can be calculated based on the pixel information of all pixel points of the two adjacent image frames. For example, brightness information of each pixel point in the image frame can be determined based on the YUV color space data or RGB color space data corresponding to each pixel point in the image frame. Then, based on the brightness information of each pixel point, the brightness difference value between the brightness information at the same pixel point in the adjacent image frames is calculated. Finally, the brightness difference information between the two adjacent image frames is calculated based on the brightness difference values of all pixel points of the two adjacent image frames.

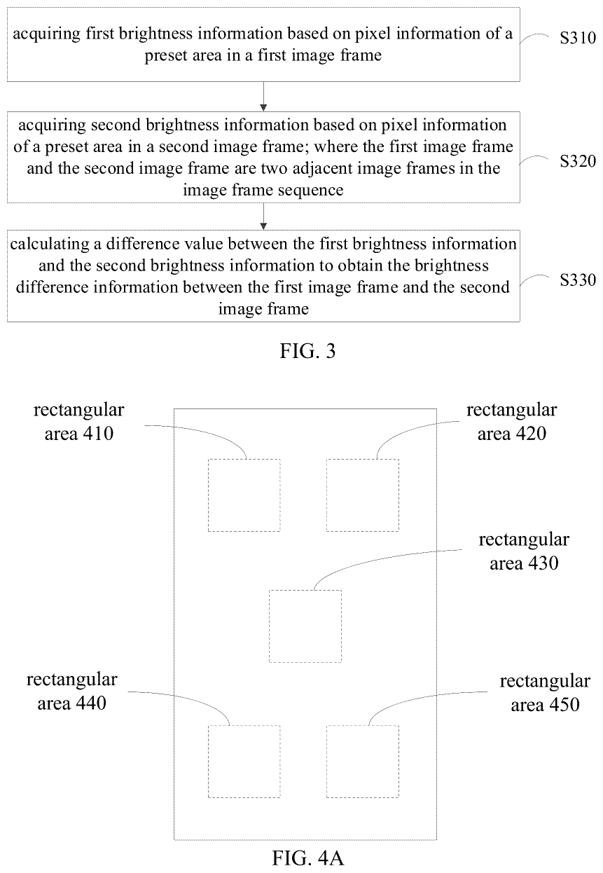

Considering the number of pixel points in the image frame, in order to reduce the amount of calculation of the brightness difference information between the image frames, it can also be determined based on the pixel information of two adjacent image frames at the pixel point in a preset area. Specifically, in one embodiment, as shown in FIG. 3, the step of acquiring the brightness difference information between every two adjacent image frames in the image frame sequence includes the following.

Step S310, acquiring first brightness information based on pixel information of a preset area in a first image frame.

Step S320, acquiring second brightness information based on pixel information of a preset area in a second image frame; where the first image frame and the second image frame are two adjacent image frames in the image frame sequence.

Step S330, calculating a difference value between the first brightness information and the second brightness information to obtain the brightness difference information between the first image frame and the second image frame.

The number of preset areas may be one or more, which is not limited here.

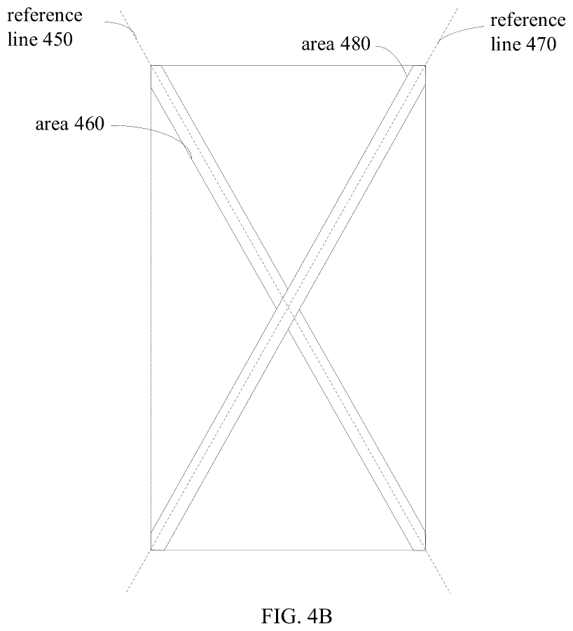

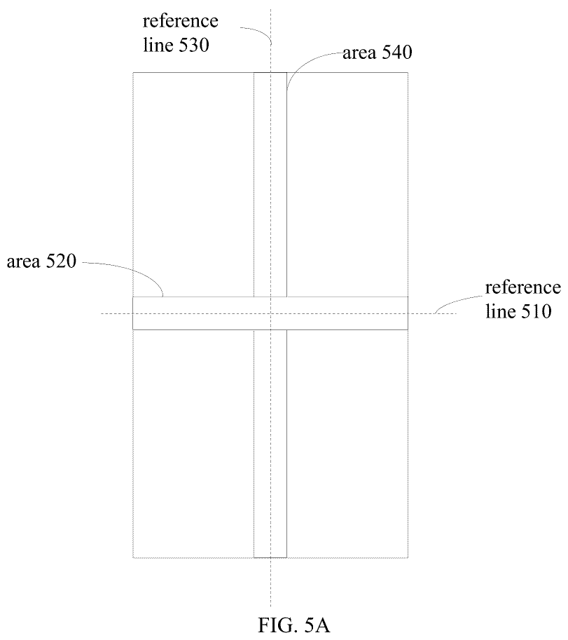

Specifically, the preset area may include multiple rectangular areas evenly distributed in the image frame (including the first image frame and the second image frame). For example, as shown in FIG. 4A, the preset area may include a rectangular area 410, a rectangular area 420, a rectangular area 430, a rectangular area 440, and a rectangular area 450 evenly distributed in the image frame.

The preset area may also include a first area with a first reference line as a center line and a second area with a second reference line as a center line in the image frame. The first reference line and the second reference line are two reference lines with different directions. It is understandable that the number of the first reference line (or first area) and the second reference line (or second area) may be one or more, and the number of the two may be equal or unequal. In addition, the first area and the second area may be rectangular areas or irregular areas, which are not limited here. For example, as shown in FIG. 4B, the first reference line may include a reference line 450. The first area with the first reference line as the center line is an area 460. The second reference line may include a reference line 470. The second area with the second reference line as the center line may be an area 480.

Further, in one embodiment, the preset area includes a first rectangular area with the first reference line as the center line and a second rectangular area with the second reference line as the center line. The first reference line is parallel to a horizontal axis of the image frame, and the second reference line is parallel to a vertical axis of the image frame.

Specifically, the first reference line and the second reference line may be reference lines with a center point of the image frame as a reference point. In one embodiment, before the step of acquiring the brightness difference information between every two adjacent image frames in the image frame sequence, the method further includes: determining the first reference line and the second reference line based on a center point of the image frame in the image frame sequence; determining the preset area in the first image frame and the preset area in the second image frame based on the first reference line and the second reference line.

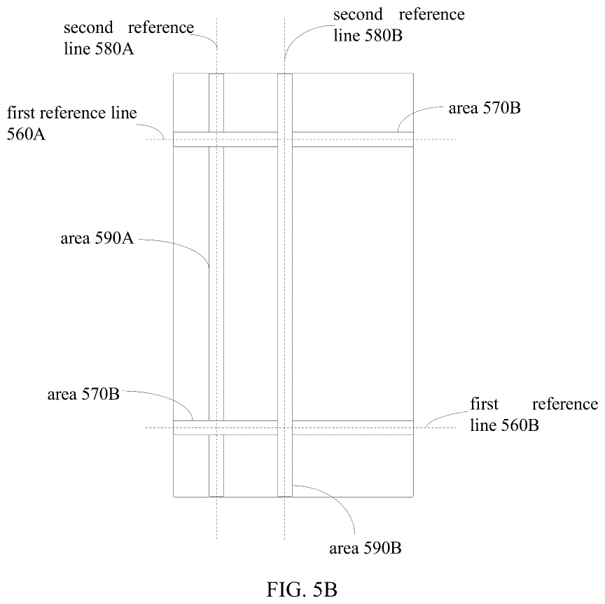

For example, as shown in FIG. 5A, the first reference line includes a reference line 510. The first rectangular area where the first reference line is the center line includes an area 520. The second reference line includes a reference line 530. The second rectangular area where the second reference line is the center line includes an area 540. The reference line 510 and the reference line 530 pass through the center point of the image frame.

The first rectangular area and the second rectangular area determined by the first reference line and the second reference line with the center point as the reference point are used to ensure effective sampling of the brightness information in the image frames of different sizes, thereby reducing the amount of calculation of the brightness difference information and ensuring the accuracy of the subsequent picture state type.

Specifically, the first reference line and the second reference line may also be reference lines with a differential pixel point of the image frame as the reference point. In one embodiment, before the step of acquiring the brightness difference information between every two adjacent image frames in the image frame sequence, the method further includes: acquiring a differential pixel point between the first image frame and the second image frame; determining the first reference line and the second reference line in the second image frame and the first image frame based on the differential pixel point; acquiring the preset area in the first image frame and the preset area in the second image frame based on the first reference line and the second reference line.

For example, as shown in FIG. 5B, the differential pixel point includes a point 550A and a point 550B. The first reference line 560A and the second reference line 580A can be determined by the point 550A. The first reference line 550B and the second reference line 580B can be determined by the point 550A. The first rectangular area with the first reference line as the center line includes areas 570A and 570B. The second rectangular area with the second reference line as the center line includes areas 590A and 590B.

The first rectangular area and the second rectangular area determined by the first reference line and the second reference line with the differential pixel point as the reference point are used to ensure effective sampling of the brightness information in the image frame, thereby reducing the amount of calculation of the brightness difference information and ensuring the accuracy of the subsequent picture state type.

After determining the preset area, the pixel information of the first image frame in the preset area can be acquired, and first brightness information can be determined based on the pixel information of the first image frame in the preset area. The pixel information of the second image frame in the preset area can be acquired, and second brightness information can be determined based on the pixel information of the second image frame in the preset area. Specifically, for the first image frame, the YUV color space data of each pixel point in the preset area of the first image frame can be acquired, and the brightness value of each pixel point in the preset area can be determined based on the brightness component in the YUV color space data corresponding to each pixel point, so as to obtain the first brightness information. For the second image frame, the YUV color space data of each pixel point in the preset area of the second image frame can be acquired, and the brightness value of each pixel point in the preset area can be determined based on the brightness component in the YUV color space data corresponding to each pixel point, so as to obtain the second brightness information.

After acquiring the first brightness information of the first image frame and the second brightness information of the second image frame, the brightness difference value of the pixel point at the same position can be calculated based on the first brightness information and the second brightness information, and then the brightness difference information between the first image frame and the second image frame can be determined based on the corresponding brightness difference values of all pixel points in the preset area.

For example, the first brightness information includes the brightness values of each pixel point in the preset area of a n-th image frame, which are denoted as

$${Y}_{1}^{1} , {Y}_{2}^{1} , … , {Y}_{x}^{1} ,$$

respectively; the second brightness information includes the brightness values of each pixel point in the preset area of a (n−1)-th image frame, which are denoted as

$${Y}_{1}^{2} , {Y}_{2}^{2} , … , {Y}_{x}^{2} ,$$

respectively; the brightness difference information between the first image frame and the second image frame can be calculated by the following formula.

$${S}_{i} = {\sum }_{x = 0}^{x} \vert {Y}_{x}^{1} - {Y}_{x}^{2} \vert .$$

$$f ( n ) = \sum {S}_{i} .$$

Sᵢ represents a sum of the difference values of the brightness values at each pixel point in an i-th preset area between the n-th image frame and the (n−1)-th image frame; f(n) represents the brightness difference information between the n-th image frame and the (n−1)-th image frame.

The brightness difference sequence includes the brightness difference information of at least two adjacent image frames. Specifically, the brightness difference information between every two adjacent image frames in the image frame sequence can be determined according to the pixel information of the two adjacent image frames obtained by the acquisition, and then the brightness difference sequence of the image frame sequence is constructed based on the obtained brightness information.

It can be understood that the brightness difference sequence of the image frame sequence is not generated all at once, but in the process of projecting the screen from the first terminal to the second terminal, each time the first terminal acquires one image frame, it can calculate the brightness difference information between the image frame and the previous image frame based on the pixel information of the latest collected image frame and the previous image frame, and save the brightness difference information to a buffer queue to obtain the brightness difference sequence corresponding to the image frame sequence.

Step S230: determining a picture state type of the image frame sequence and a screen projection frame rate corresponding to the picture state type based on the brightness difference sequence.

The picture state type is used to identify a speed of image changes in the image frame sequence collected by the first terminal. Specifically, the picture state type of the image frame sequence can be determined based on the speed of image changes. For example, the picture state type can be divided into a static picture type and a dynamic picture type. For another example, the picture state type can be divided into a game picture type, a video picture type, and a PPT picture type.

The screen projection frame rate refers to a frequency at which the first terminal sends an image frame to the second terminal. For the screen projection frame rates corresponding to different picture state types, it can be understood that when the image picture corresponding to the picture state type changes faster, the corresponding screen projection frame rate is larger, and when the image picture corresponding to the picture state type changes slower, the corresponding screen projection frame rate is smaller. For example, when displaying a video or playing a game, an user is more sensitive to picture synchronization and picture fluency, and the higher the screen projection frequency of the image frame sequence, the better the experience. On the contrary, when the screen is only projected during the viewing and switching of static pages, the user does not perceive the picture synchronization and picture fluency obviously, as long as the screen projection frame rate that meets a human eye optical residual threshold of 1/24 seconds is smooth. Taking the picture state type including the static picture type and the dynamic picture type as an example, the screen projection frame rate corresponding to the static picture type is less than the screen projection frame rate corresponding to the dynamic picture type; for another example, taking the picture state type including the game picture type, the video picture type and the PPT picture type as an example, the screen projection frame rates corresponding to the game picture type, the video picture type and the PPT picture type decrease in sequence.

When determining the picture state type of an image frame sequence acquired in real time, in order to avoid frequent adjustment of the screen projection frame rate due to the switching change of the picture state type, a fuzzy interval can be set to achieve inert switching of the picture state type. Taking the picture state type including the static picture type and the dynamic picture type as an example, in one embodiment, the picture state type includes the dynamic picture type and the static picture type. The step of determining the picture state type of the image frame sequence and the screen projection frame rate corresponding to the picture state type based on the brightness difference sequence includes: if a continuous preset number of brightness difference information in the brightness difference sequence are all greater than a first brightness threshold, determining that the image frame sequence is the dynamic picture type, and determining that the screen projection frame rate is a first frame rate; if the continuous preset number of brightness difference information in the brightness difference sequence are all less than or equal to the first brightness threshold, determining that the image frame sequence is the static picture type, and determining that the screen projection frame rate is a second frame rate; where the first frame rate is greater than the second frame rate.

Specifically, each time the first terminal collects one image frame, it can calculate the brightness difference information between the image frame and a previous image frame based on the pixel information of the latest collected image frame and the previous image frame, and save the brightness difference information to a buffer queue to obtain the brightness difference sequence. At this time, based on the brightness difference information, the number of brightness difference information that is continuously greater than the first brightness threshold in the brightness difference sequence can be counted in real time, or the number of brightness difference information that is continuously less than or equal to the first brightness threshold in the brightness difference sequence can be counted. If the continuous preset number of brightness difference information in the brightness difference sequence are greater than the first brightness threshold, the image frame sequence is determined to be the dynamic picture type. If N (N is greater than 1) consecutive brightness difference information in the brightness difference sequence are less than or equal to the first brightness threshold, the image frame sequence is determined to be the static picture type.

For example, taking N as 30, if 30 consecutive f(n) are less than or equal to the

$${T}_{Y}^{1} ,$$

the image frame sequence is considered to be the static picture type. If 30 consecutive f(n) are greater than

$${T}_{Y}^{1} ,$$

the image frame sequence is considered to be the dynamic picture type.

$${T}_{Y}^{1}$$

represents the first brightness threshold.

More specifically, in the process of projecting the screen from the first terminal to the second terminal, the latest collected target image frame in the image frame sequence can be determined, and target brightness difference information between a target image frame and the previous image frame can be acquired. If the target brightness difference information and (N−1) brightness difference information in the brightness difference sequence that are continuous with the target brightness difference information are both greater than the brightness difference information of the first brightness threshold, the image frame sequence is determined to be the dynamic picture type, and the screen projection frame rate is determined to be the first frame rate. If the target brightness difference information and the (N−1) brightness difference information in the brightness difference sequence that are continuous with the target brightness difference information are both less than or equal to the brightness difference information of the first brightness threshold, the image frame sequence is determined to be the static picture type, and the screen projection frame rate is determined to be the second frame rate.

Similarly, when the number of the picture state types is three or more, a corresponding brightness threshold may be set for each picture state type, and then the brightness difference information in the brightness difference sequence is compared with each brightness threshold to determine the picture state type corresponding to the image frame sequence. Taking the picture state type including the game picture type, the video picture type, and the PPT picture type as an example, the steps of determining the picture state type of the image frame sequence and the screen projection frame rate corresponding to the picture state type based on the brightness difference sequence include: if a continuous preset number of brightness difference information in the brightness difference sequence are greater than a second brightness threshold, determining the image frame sequence is the game picture type, and determining the screen projection frame rate is a third frame rate; if the continuous preset number of brightness difference information in the brightness difference sequence are less than or equal to the second brightness threshold and greater than a third brightness threshold, determining the image frame sequence is the video picture type, and determining the screen projection frame rate is a fourth frame rate; if the continuous preset number of brightness difference information in the brightness difference sequence is less than the third brightness threshold, determining the image frame sequence is the PPT picture type, and determining the screen projection frame rate is a fifth frame rate; where the third frame rate is greater than the fourth frame rate, and the fourth frame rate is greater than the fifth frame rate.

For example, taking N as 30, if 30 consecutive f(n) are less than or equal to

$${T}_{Y}^{2} ,$$

the image frame sequence is considered to be the PPT picture type. If 30 consecutive f(n) are greater than

$${T}_{Y}^{2}$$

and less than or equal to

$${T}_{Y}^{3} ,$$

the image frame sequence is considered to be the video picture type. If 30 consecutive f(n), are greater than

$${T}_{Y}^{3} ,$$

the image frame sequence is considered to be the game picture type.

$${T}_{Y}^{2} and {T}_{Y}^{3}$$

represent the second brightness threshold and the third brightness threshold, respectively.

Step S240, sending image frames in the image frame sequence to a second terminal at the screen projection frame rate.

After the screen projection frame rate is determined, the image frames in the image frame sequence can be sent to the second terminal at the screen projection frame rate. It is understandable that the image frame rate sequence can be sent to the second terminal at the screen projection frame rate based on a mirroring screen projection protocol (Miracast protocol).

Specifically, in one embodiment, the step of sending the image frames in the image frame sequence to the second terminal at the screen projection frame rate includes: determining a screen projection interval time based on the screen projection frame rate; acquiring a latest collected target image frame in the image frame sequence and an actual interval time between the target image frame and a previously sent image frame; if the actual interval time is less than the screen projection interval time, discarding the target image frame; if the actual interval time is greater than or equal to the screen projection interval time, sending the target image frame to the second terminal.

The screen projection interval time refers to the interval time between the two image frames sent during the projection process. Specifically, during the projection process from the first terminal to the second terminal, after acquiring the latest collected target image frame in the image frame sequence, the actual interval time between the target image frame and the last image frame sent can be calculated. If the actual interval time is less than the screen projection interval time, the target image frame is discarded to reduce a pressure of image frame encoding and image frame sending. If the actual interval time is greater than or equal to the screen projection interval time, the target image frame is packaged and sent normally to ensure the smoothness of the projection picture.

At the same time, in one embodiment, after the step of determining the screen projection frame rate corresponding to the picture state type, the step further includes: sending the screen projection frame rate to the second terminal so that the second terminal displays a received image frame according to the screen projection frame rate. By sending the screen projection frame rate to the second terminal, the second terminal updates the display frame rate of the image frame based on the screen projection frame rate, thereby ensuring picture synchronization between the first terminal and the second terminal.

In the above screen projection frame rate acquisition method, the image frame sequence to be projected is collected; the brightness difference information between every two adjacent image frames in the image frame sequence is acquired to obtain the brightness difference sequence of the image frame sequence; the picture state type of the image frame sequence and the screen projection frame rate corresponding to the picture state type are determined based on the brightness difference sequence; and the image frames in the image frame sequence are sent to the second terminal at the screen projection frame rate. The brightness difference information of the image frame sequence corresponding to the screen picture in the first terminal is used to detect the picture state type of the screen picture, and then the screen projection frame rate is dynamically adjusted based on the picture state type, thereby reducing terminal power consumption while ensuring smoothness of pictures during a projection process.

Taking into account an impact of a communication bandwidth between the first terminal and the second terminal on the transmission of the image frame sequence, in one embodiment, before the step of acquiring the brightness difference information between every two adjacent image frames in the image frame sequence to obtain the brightness difference sequence of the image frame sequence, acquiring a transmission bandwidth between the second terminal; if the transmission bandwidth is greater than a preset bandwidth threshold, executing the step of acquiring the brightness difference information between every two adjacent image frames in the image frame sequence to obtain the brightness difference sequence of the image frame sequence.

Furthermore, if the transmission bandwidth information is less than or equal to the preset bandwidth threshold, the image frames in the image frame sequence are sent to the second terminal at a fixed frame rate.

The preset bandwidth threshold can be set according to actual conditions. In one embodiment, the preset bandwidth threshold can be set to 50 Mbps. Specifically, the first terminal can calculate a data volume of transmission information, a transmission time of the transmission information, and a reception time of response information made by the second terminal based on the transmission information, and then calculate the transmission bandwidth between the first terminal and the second terminal.

After determining the transmission bandwidth, the transmission bandwidth can be compared with the preset bandwidth threshold. When the transmission bandwidth is greater than the preset bandwidth threshold, a step of acquiring the brightness difference information of two consecutive frame pictures in the image frame sequence based on the pixel information of the two consecutive frame pictures in the image frame sequence is performed, so that the first terminal can determine the picture state type based on the brightness difference information, and then adjust the screen projection frame rate based on the picture state type. When the transmission bandwidth is less than or equal to the preset bandwidth threshold, the screen projection frame rate is determined to be a fixed frame rate, so that the first terminal sends the image frame sequence at the fixed frame rate and stops determining the picture state type.

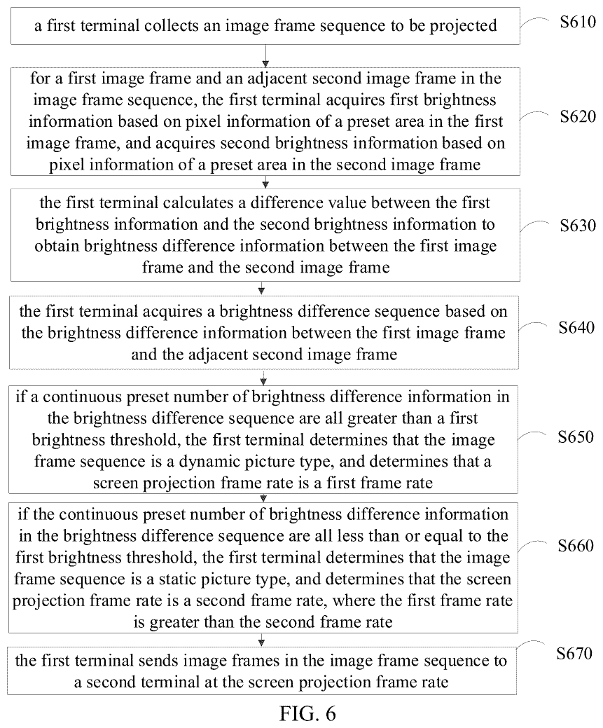

The screen projection frame rate acquisition method provided by the embodiments of the present application is further described below in conjunction with the application scenario of FIG. 1. In one embodiment, as shown in FIG. 6 and FIG. 7, the screen projection frame rate acquisition method includes the following.

S610, a first terminal collects an image frame sequence to be projected.

Referring to FIG. 7, the first terminal serves as a source end and can perform screen recording and sampling of a content displayed on a screen from a media source (surfacemediasource) in real time through a media streaming module (Media Puller) to obtain the image frame sequence.

S620, for a first image frame and an adjacent second image frame in the image frame sequence, the first terminal acquires first brightness information based on pixel information of a preset area in the first image frame, and acquires second brightness information based on pixel information of a preset area in the second image frame.

Since there are a huge number of pixel points in one image frame, in order to reduce the computational complexity of brightness difference information and ensure that the brightness information of the image frame in a landscape mode or the image frame in a portrait mode of the first terminal can be effectively sampled, as shown in FIG. 5A, a preset area may include a first rectangular area with a first reference line as a center line and a second rectangular area with a second reference line as a center line. The first reference line is parallel to a horizontal axis of the image frame, and the second reference line is parallel to a vertical axis of the image frame.

S630, the first terminal calculates a difference value between the first brightness information and the second brightness information to obtain brightness difference information between the first image frame and the second image frame.

S640, the first terminal acquires a brightness difference sequence based on the brightness difference information between the first image frame and the adjacent second image frame.

S650, if a continuous preset number of brightness difference information in the brightness difference sequence are all greater than a first brightness threshold, the first terminal determines that the image frame sequence is a dynamic picture type, and determines that a screen projection frame rate is a first frame rate.

S660, if the continuous preset number of brightness difference information in the brightness difference sequence are all less than or equal to the first brightness threshold, the first terminal determines that the image frame sequence is a static picture type, and determines that the screen projection frame rate is a second frame rate, where the first frame rate is greater than the second frame rate.

As shown in FIG. 7, the first terminal acquires each image frame through the media streaming module (Media Puller), sends the image frame to a frame detection module (FrameDetecter), and detects the target brightness difference information between the current image frame and the previous image frame in real time through the frame detection module. If the target brightness difference information and (N−1) historical brightness difference information in the brightness difference sequence that are continuous with the target brightness difference information are both greater than the brightness difference information of the first brightness threshold, the image frame sequence is determined to be the dynamic picture type, and the screen projection frame rate is determined to be the first frame rate. If the target brightness difference information and the (N−1) historical brightness difference information in the brightness difference sequence that are continuous with the target brightness difference information are both less than or equal to the brightness difference information of the first brightness threshold, the image frame sequence is determined to be the static picture type, and the screen projection frame rate is determined to be the second frame rate.

S670, the first terminal sends image frames in the image frame sequence to a second terminal at the screen projection frame rate.

Referring to FIG. 7, the acquired screen projection frame rate is sent to a frame rate change determination module through the frame detection module, and the frame rate change determination module determines whether a newly received screen projection frame rate is the same as the current screen projection frame rate. If they are different, the screen projection frame rate is sent to change, and the newly received screen projection frame rate is sent to a frame interval threshold module (frame interval threshold) and a network session module (network session). The frame interval threshold module receives the new screen projection frame rate to adjust the screen projection interval time. After receiving the new screen projection frame rate, the network session module notifies the second terminal of the new screen projection frame rate through a RTSP (Real Time Streaming Protocol) protocol, so that the second terminal updates its display frame rate according to the new screen projection frame rate.

The first terminal acquires each image frame through the media streaming module (Media Puller), and sends the image frame to the frame interval threshold module. After acquiring the latest collected image frame, the frame interval threshold module can calculate an actual interval time between the image frame and the last image frame sent. When the actual interval time is greater than or equal to a screen projection interval time, the image frame is sent to a coded transmission module. The coded transmission module encodes the image frame and sends it to the second terminal to achieve screen projection. If the actual interval time is less than the screen projection interval time, the image frame is discarded to reduce a pressure of image frame encoding and image frame sending in the coded transmission module.

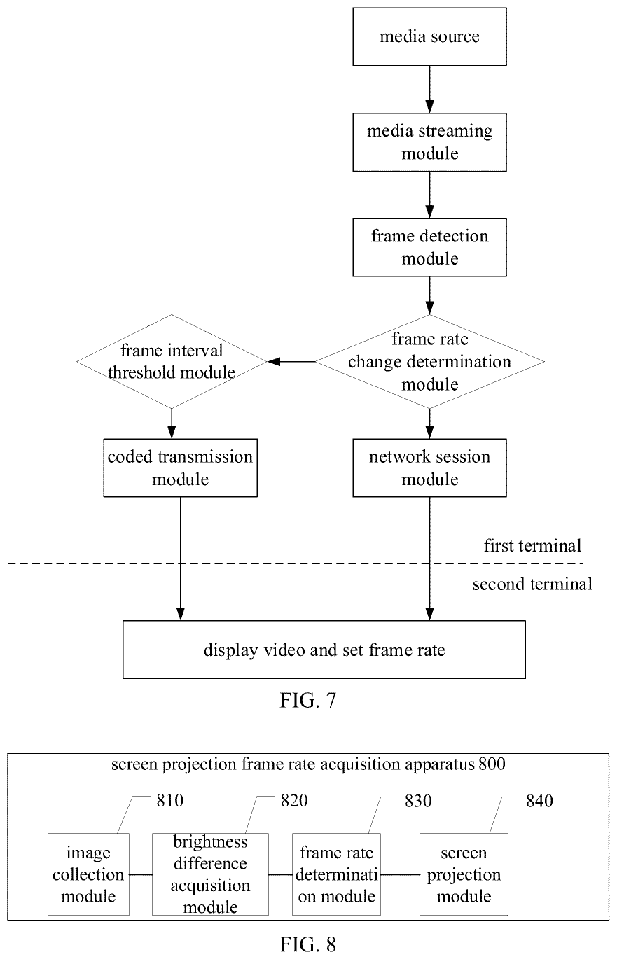

In order to better implement the screen projection frame rate acquisition method provided by the embodiments of the present application, on the basis of the screen projection frame rate acquisition method provided by the embodiments of the present application, an embodiment of the present application further provides a screen projection frame rate acquisition apparatus. As shown in FIG. 8, a screen projection frame rate acquisition apparatus 800 includes the following.

An image collection module 810 is configured to collect an image frame sequence to be projected.

A brightness difference acquisition module 820 is configured to acquire brightness difference information between every two adjacent image frames in the image frame sequence to obtain a brightness difference sequence of the image frame sequence.

A frame rate determination module 830 is configured to determine a picture state type of the image frame sequence and a screen projection frame rate corresponding to the picture state type based on the brightness difference sequence.

A screen projection module 840 is configured to send image frames in the image frame sequence to a second terminal at the screen projection frame rate.

In some embodiments of the present application, the brightness difference acquisition module 820 is specifically configured to: acquire first brightness information based on pixel information of a preset area in a first image frame; acquire second brightness information based on pixel information of a preset area in a second image frame, where the first image frame and the second image frame are two adjacent image frames in the image frame sequence; calculate a difference value between the first brightness information and the second brightness information to obtain the brightness difference information between the first image frame and the second image frame.

In some embodiments of the present application, the preset area includes a first area with a first reference line as a center line and a second area with a second reference line as a center line; where the first reference line and the second reference line are reference lines with different directions.

In some embodiments of the present application, the preset area includes a first rectangular area with a first reference line as a center line and a second rectangular area with a second reference line as a center line; where the first reference line is parallel to a horizontal axis of an image frame, and the second reference line is parallel to a vertical axis of the image frame.

In some embodiments of the present application, the brightness difference acquisition module 820 is further configured to: determine the first reference line and the second reference line based on a center point of the image frame in the image frame sequence; and determine the preset area in the first image frame and the preset area in the second image frame based on the first reference line and the second reference line.

In some embodiments of the present application, the brightness difference acquisition module 820 is further configured to: acquire a differential pixel point between the first image frame and the second image frame; determine the first reference line and the second reference line in the second image frame and the first image frame based on the differential pixel point; acquire the preset area in the first image frame and the preset area in the second image frame based on the first reference line and the second reference line.

In some embodiments of the present application, the picture state type includes a dynamic picture type and a static picture type; the frame rate determination module 830 is specifically configured to determine that the image frame sequence is the dynamic picture type and the screen projection frame rate is a first frame rate if a continuous preset number of brightness difference information in the brightness difference sequence are all greater than a first brightness threshold; and to determine that the image frame sequence is the static picture type and the screen projection frame rate is a second frame rate if the continuous preset number of brightness difference information in the brightness difference sequence are all less than or equal to the first brightness threshold; the first frame rate is greater than the second frame rate.

In some embodiments of the present application, the screen projection frame rate acquisition apparatus further includes a bandwidth acquisition module configured to acquire a transmission bandwidth between the second terminal; when the transmission bandwidth is greater than a preset bandwidth threshold, the brightness difference acquisition module 820 executes the step of acquiring the brightness difference information between every two adjacent image frames in the image frame sequence to obtain the brightness difference sequence of the image frame sequence.

In some embodiments of the present application, when the transmission bandwidth information is less than or equal to a preset bandwidth threshold, the brightness difference acquisition module 820 is configured to send the image frames in the image frame sequence to the second terminal at a fixed frame rate.

In some embodiments of the present application, the screen projection module 840 is configured to determine a screen projection interval time based on the screen projection frame rate; acquire a latest collected target image frame in the image frame sequence and an actual interval time between the target image frame and a previously sent image frame; if the actual interval time is less than the screen projection interval time, discard the target image frame; if the actual interval time is greater than or equal to the screen projection interval time, send the target image frame to the second terminal.

In some embodiments of the present application, the screen projection frame rate acquisition apparatus further includes a frame rate sending module, which is configured to send the screen projection frame rate to the second terminal so that the second terminal displays a received image frame according to the screen projection frame rate.

For the specific definition of the screen projection frame rate acquisition apparatus, please refer to the definition of the screen projection frame rate acquisition method above, which will not be repeated here. The various modules in the above-mentioned screen projection frame rate acquisition apparatus can be implemented in whole or in part by software, hardware, and a combination thereof. The above-mentioned modules can be embedded in or independent of a processor in a computer device in the form of hardware, or can be stored in a memory in the computer device in the form of software, so that the processor can call and execute the operations corresponding to the above modules.

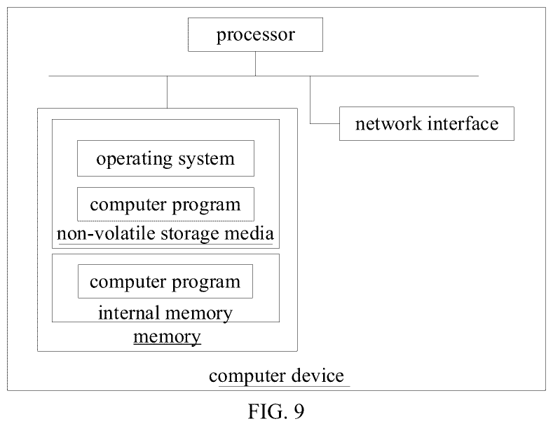

In some embodiments of the present application, the screen projection frame rate acquisition apparatus 800 can be implemented in the form of a computer program. The computer program can be run on a computer device as shown in FIG. 9. A memory of the computer device can store various program modules constituting the screen projection frame rate acquisition apparatus 800, such as the image collection module 810, the brightness difference acquisition module 820, the frame rate determination module 830, and the screen projection module 840 shown in FIG. 8. The computer program composed of the various program modules enables the processor to execute the steps of the screen projection frame rate acquisition method of various embodiments of the present application described in this specification.

For example, the computer device shown in FIG. 9 can perform the step S210 through the image collection module 810 in the screen projection frame rate acquisition apparatus 800 shown in FIG. 8. The computer device can perform the step S220 through the brightness difference acquisition module 820. The computer device can perform the step S230 through the frame rate determination module 830. The computer device can perform step the S240 through the screen projection module 840. The computer device includes a processor, a memory, and a network interface connected through a system bus. Among them, the processor of the computer device is used to provide computing and control capabilities. The memory of the computer device includes non-volatile storage media and internal memory. The non-volatile storage media stores an operating system and a computer program. The internal memory provides an environment for the operation of the operating system and the computer program in the non-volatile storage media. The network interface of the computer device is used to communicate with an external computer device through a network connection. When the computer program is executed by the processor, the screen projection frame rate acquisition method is implemented.

Those skilled in the art will appreciate that the structure shown in FIG. 9 is merely a block diagram of a portion of the structure related to the present application solution, and does not constitute a limitation on the computer device to which the present application solution is applied. A specific computer device may include more or fewer components than those shown in the figure, or combine certain components, or have a different arrangement of components.

In some embodiments of the present application, a computer device is provided, including one or more processors; a memory; and one or more applications, where the one or more applications are stored in the memory and configured to be executed by the processor to perform the steps of the above-mentioned screen projection frame rate acquisition method. Here, the steps of the screen projection frame rate acquisition method may be the steps of the screen projection frame rate acquisition method in each of the above-mentioned embodiments.

In some embodiments of the present application, a computer-readable storage medium is provided, which stores a computer program, and the computer program is loaded by a processor, so that the processor executes the steps of the above-mentioned screen projection frame rate acquisition method. Here, the steps of the screen projection frame rate acquisition method can be the steps of the screen projection frame rate acquisition method in each of the above-mentioned embodiments.

Those skilled in the art can understand that all or part of the processes in the above-mentioned embodiments can be completed by instructing the relevant hardware through a computer program. The computer program can be stored in a non-volatile computer-readable storage medium. When the computer program is executed, it can include the processes of the embodiments of the above-mentioned methods. Any reference to memory, storage, database or other media used in the embodiments provided by the present application can include at least one of non-volatile and volatile memory. The non-volatile memory can include a read-only memory (ROM), a magnetic tape, a floppy disk, a flash memory, or an optical memory, etc. The volatile memory can include a random access memory (RAM) or an external cache memory. As an illustration and not limitation, the RAM can be in various forms, such as static random access memory (SRAM) or dynamic random access memory (DRAM).

The technical features of the above embodiments may be arbitrarily combined. To make the description concise, not all possible combinations of the technical features in the above embodiments are described. However, as long as there is no contradiction in the combination of these technical features, they should be considered to be within the scope of this specification.

The above is a detailed introduction to the screen projection frame rate acquisition method, the apparatus, the computer device, and the storage medium provided in the embodiments of the present application. Specific examples are used in this specification to illustrate the principle and implementation of the present invention. The description of the above embodiments is only used to help understand the method of the present invention and its core idea. At the same time, for those skilled in the art, according to the idea of the present invention, there will be changes in the specific implementation method and application scope. In summary, the content of this specification should not be understood as limiting the present invention.

1. A screen projection frame rate acquisition method, applied to a first terminal, and the method comprising:
collecting an image frame sequence to be projected;
acquiring brightness difference information between every two adjacent image frames in the image frame sequence to obtain a brightness difference sequence of the image frame sequence;
determining a picture state type of the image frame sequence and a screen projection frame rate corresponding to the picture state type based on the brightness difference sequence;
sending image frames in the image frame sequence to a second terminal at the screen projection frame rate.

2. The method according to claim 1, wherein the acquiring the brightness difference information between every two adjacent image frames in the image frame sequence comprises:
acquiring first brightness information based on pixel information of a preset area in a first image frame;
acquiring second brightness information based on pixel information of a preset area in a second image frame; wherein the first image frame and the second image frame are two adjacent image frames in the image frame sequence;
calculating a difference value between the first brightness information and the second brightness information to obtain the brightness difference information between the first image frame and the second image frame.

3. The method according to claim 2, wherein the preset area comprises a first area with a first reference line as a center line and a second area with a second reference line as a center line; wherein the first reference line and the second reference line are reference lines with different directions.

4. The method according to claim 2, wherein the preset area comprises a first rectangular area with a first reference line as a center line and a second rectangular area with a second reference line as a center line; wherein the first reference line is parallel to a horizontal axis of an image frame, and the second reference line is parallel to a vertical axis of the image frame.

5. The method according to claim 3, before acquiring the brightness difference information between every two adjacent image frames in the image frame sequence, further comprising:
determining the first reference line and the second reference line based on a center point of the image frame in the image frame sequence;
determining the preset area in the first image frame and the preset area in the second image frame based on the first reference line and the second reference line.

6. The method according to claim 3, before acquiring the brightness difference information between every two adjacent image frames in the image frame sequence, further comprising:
acquiring a differential pixel point between the first image frame and the second image frame;
determining the first reference line and the second reference line in the second image frame and the first image frame based on the differential pixel point;
acquiring the preset area in the first image frame and the preset area in the second image frame based on the first reference line and the second reference line.

7. The method according to claim 1, wherein the picture state type comprises a dynamic picture type and a static picture type;
the determining the picture state type of the image frame sequence and the screen projection frame rate corresponding to the picture state type based on the brightness difference sequence comprises:
if a continuous preset number of brightness difference information in the brightness difference sequence are all greater than a first brightness threshold, determining that the image frame sequence is the dynamic picture type, and determining that the screen projection frame rate is a first frame rate;
if the continuous preset number of brightness difference information in the brightness difference sequence are all less than or equal to the first brightness threshold, determining that the image frame sequence is the static picture type, and determining that the screen projection frame rate is a second frame rate;
wherein the first frame rate is greater than the second frame rate.

8. The method according to claim 1, before acquiring the brightness difference information between every two adjacent image frames in the image frame sequence to obtain the brightness difference sequence of the image frame sequence, further comprising:
acquiring a transmission bandwidth between the first terminal and the second terminal;
the acquiring the brightness difference information between every two adjacent image frames in the image frame sequence to obtain the brightness difference sequence of the image frame sequence comprises:
if the transmission bandwidth is greater than a preset bandwidth threshold, acquiring the brightness difference information between every two adjacent image frames in the image frame sequence to obtain the brightness difference sequence of the image frame sequence.

9. The method according to claim 8, after acquiring the transmission bandwidth between the first terminal and the second terminal, further comprising:
if the transmission bandwidth is less than or equal to the preset bandwidth threshold, sending the image frames in the image frame sequence to the second terminal at a fixed frame rate.

10. The method according to claim 1, wherein the sending the image frames in the image frame sequence to the second terminal at the screen projection frame rate comprises:
determining a screen projection interval time based on the screen projection frame rate;
acquiring a latest collected target image frame in the image frame sequence and an actual interval time between the target image frame and a previously sent image frame;
if the actual interval time is less than the screen projection interval time, discarding the target image frame;
if the actual interval time is greater than or equal to the screen projection interval time, sending the target image frame to the second terminal.

11. The method according to claim 1, after determining the screen projection frame rate corresponding to the picture state type, further comprising:
sending the screen projection frame rate to the second terminal so that the second terminal displays a received image frame according to the screen projection frame rate.

12. The method according to claim 2, wherein the calculating the difference value between the first brightness information and the second brightness information to obtain the brightness difference information between the first image frame and the second image frame comprises:
calculating by a formula
$${S}_{i} = {\sum }_{x = 0}^{x} \vert {Y}_{x}^{1} - {Y}_{x}^{2} \vert , f ( n ) = \sum {S}_{i}$$
to obtain the brightness difference information between the first image frame and the second image frame; wherein the first brightness information comprises brightness values of each pixel point in a preset area of a n-th image frame, respectively denoted as
$${Y}_{1}^{1} , {Y}_{2}^{1} , … , {Y}_{x}^{1} ;$$
the second brightness information comprises brightness values of each pixel point in a preset area of a (n−1)-th image frame, respectively denoted as
$${Y}_{1}^{2} , {Y}_{2}^{2} , … , {Y}_{x}^{2} ;$$
Sᵢ represents a sum of difference values of the brightness values of each pixel point in an i-th preset area between the n-th image frame and the (n−1)-th image frame; f(n) represents the brightness difference information between the n-th image frame and the (n−1)-th image frame.

13. The method according to claim 1, wherein the picture state type comprises a game picture type, a video picture type, and a PPT picture type;
the determining the picture state type of the image frame sequence and the screen projection frame rate corresponding to the picture state type based on the brightness difference sequence comprises:
if a continuous preset number of brightness difference information in the brightness difference sequence are greater than a second brightness threshold, determining the image frame sequence is the game picture type, and determining the screen projection frame rate is a third frame rate;
if the continuous preset number of brightness difference information in the brightness difference sequence are less than or equal to the second brightness threshold and greater than a third brightness threshold, determining the image frame sequence is the video picture type, and determining the screen projection frame rate is a fourth frame rate;
if the continuous preset number of brightness difference information in the brightness difference sequence is less than the third brightness threshold, determining the image frame sequence is the PPT picture type, and determining the screen projection frame rate is a fifth frame rate;
wherein the third frame rate is greater than the fourth frame rate, and the fourth frame rate is greater than the fifth frame rate.

14. A screen projection frame rate acquisition apparatus, wherein the apparatus comprises:
an image collection module configured to collect an image frame sequence to be projected;
a brightness difference acquisition module configured to acquire brightness difference information between every two adjacent image frames in the image frame sequence to obtain a brightness difference sequence of the image frame sequence;
a frame rate determination module configured to determine a picture state type of the image frame sequence and a screen projection frame rate corresponding to the picture state type based on the brightness difference sequence;
a screen projection module configured to send image frames in the image frame sequence to a second terminal at the screen projection frame rate.

15. The apparatus according to claim 14, wherein the brightness difference acquisition module is configured to: acquire first brightness information based on pixel information of a preset area in a first image frame; acquire second brightness information based on pixel information of a preset area in a second image frame, wherein the first image frame and the second image frame are two adjacent image frames in the image frame sequence; calculate a difference value between the first brightness information and the second brightness information to obtain the brightness difference information between the first image frame and the second image frame.

16. The apparatus according to claim 15, wherein the preset area comprises a first area with a first reference line as a center line and a second area with a second reference line as a center line; wherein the first reference line and the second reference line are reference lines with different directions.

17. The apparatus according to claim 15, wherein the preset area comprises a first rectangular area with a first reference line as a center line and a second rectangular area with a second reference line as a center line; wherein the first reference line is parallel to a horizontal axis of an image frame, and the second reference line is parallel to a vertical axis of the image frame.

18. The apparatus according to claim 16, wherein the brightness difference acquisition module is further configured to: determine the first reference line and the second reference line based on a center point of the image frame in the image frame sequence; and determine the preset area in the first image frame and the preset area in the second image frame based on the first reference line and the second reference line.

19-20. (canceled)

21. The apparatus according to claim 16, wherein the brightness difference acquisition module is further configured to: acquire a differential pixel point between the first image frame and the second image frame; determine the first reference line and the second reference line in the second image frame and the first image frame based on the differential pixel point; acquire the preset area in the first image frame and the preset area in the second image frame based on the first reference line and the second reference line.

22. The apparatus according to claim 14, wherein the picture state type comprises a dynamic picture type and a static picture type; the frame rate determination module is further configured to determine that the image frame sequence is the dynamic picture type and the screen projection frame rate is a first frame rate if a continuous preset number of brightness difference information in the brightness difference sequence are all greater than a first brightness threshold; and to determine that the image frame sequence is the static picture type and the screen projection frame rate is a second frame rate if the continuous preset number of brightness difference information in the brightness difference sequence are all less than or equal to the first brightness threshold; wherein the first frame rate is greater than the second frame rate.
